(19) United States
(12) Patent Application Publication
(10) Pub. No.: US 2011/0167201 A1
(43) Pub. Date: Jul. 7, 2011

(54) EXPANDABLE CAPACITY SOLID STATE DRIVE

(76) Inventor: Ching-Hsiang Simon Huang, Irvine, CA (US)

(21) Appl. No.: 12/986,116

(22) Filed: Jan. 6, 2011

Related U.S. Application Data
(60) Provisional application No. 61/292,816, filed on Jan. 6, 2010.

(51) Int. Cl. G06F 12/00

(52) U.S. Cl. 711/103; 711/115; 711/E12.008

(57) ABSTRACT

An expandable solid state drive is provided, comprising a main printed circuitboard, wherein the main printed circuitboard comprises a controller, an interface to a host, and connectors suitable to removably receive connectors mounted on a daughter card, the daughter card comprising at least one non-volatile flash memory chip, wherein when the daughter card is received by the main printed circuitboard, the form factor of the expandable solid state device is maintained.

### PRIORITY CLAIM

This patent application claims the benefit of the filing date of the U.S. Provisional Patent Application Ser. No. 61/292,816, filed Jan. 6, 2010 and entitled EXPANDABLE CAPACITY SOLID STATE DISK, the entire contents of which are hereby expressly incorporated by reference.

### BACKGROUND

1. Field

This application relates to solid-state drives.

2. Description of the Related Art

Solid-state drives (SSD), also known as flash drives, are becoming more common in consumer-grade non-volatile storage. SSD is attractive because compared to traditional platter-based disks, it offers faster read/write times, reduced power consumption and has no moving parts. Historically, it has been cost-prohibitive to use SSDs instead of traditional platter-based hard drives for long term non-volatile storage. Today, the typical SSD is a significant increase in cost over a conventional platter hard drive for the same capacity. Per gigabyte, a SSD now typically costs ten to twenty times the price of a platter-based disk hard drive.

Concurrently, consumers continue to store ever-increasing amounts of data, including music, video and other multimedia applications. Today, users must purchase a fixed-capacity SSD. Upon receipt from the retailer, a user has no ability to increase the capacity of a SSD. This has drawbacks for the user, because if the user seeks to increase the capacity of storage in his device, he must purchase an entirely new device and replace the old device. Alternatively, the user may be able to access the old and new devices simultaneously, but only if the user has sufficient interfaces from the host to the additional devices.

Historically, non-volatile storage drives have not been intended for user modification. Platter-based hard drives were not suitable for any user modification due to delicate electromechanical components and were presented to a user with sealed covers not intended for consumer removal.

### SUMMARY

The expandable capacity solid-state drive presented offers several advantages over previous solid-state drives. One aspect of the expandable solid state drive is that the user can increase the capacity of the solid state drive by inserting a daughter card into a main printed circuitboard. The form factor of the device may be maintained after the daughter card is in place, which allows continued compatibility of the device with other devices and system architectures after the capacity is increased.

The expandable solid state drive also allows insertion of at least one daughter card and allows virtualization across the solid state memory within the device. The device may aggregate the size of non-volatile memory chips and present a total logical capacity substantially equivalent to the sum of the logical capacity of the individual chips through the interface.

Another aspect of the device is that it may allow for cloning of data across flash memory chips from one location to another. This allows a user to clone data across memory and subsequently replace the expandable module of non-volatile memory with an equivalent or increased capacity.

In one embodiment of the disclosure, a non-volatile storage device is provided, which includes a printed circuitboard. The non-volatile storage device also includes a controller, capable of interfacing with non-volatile memory. The non-volatile storage device also includes an interface, capable of providing logical access to the controller for an external host. The non-volatile storage device also includes at least one connector suitable for removably receiving at least one daughter card, wherein each daughter card includes at least one mating connector and at least one non-volatile solid-state memory module. The non-volatile storage device also includes an interface bus, providing an electrical connection between said connectors and said controller. The controller is configured to utilize the at least one non-volatile memory module when the at least one daughter card is removably received, and a form factor of the non-volatile storage device is maintained after receipt of the at least one daughter card. In an embodiment, the form factor of the device is one of a standard 3.5, 2.5, or 1.8 inch drive. In an embodiment, the printed circuitboard further includes a main non-volatile memory. In an embodiment, the controller is further configured to aggregate the capacities of the main non-volatile memory and the non-volatile memory module of the at least one received daughter card and present the aggregated capacities to the external host. In an embodiment, the interface bus includes a plurality of channels, each channel capable of addressing a limited set of non-volatile memory modules, wherein each of the at least one connector includes a channel for communication with a daughter card. In an embodiment, the controller is configured for communication with non-volatile memory modules of the daughter card which comprise any of MLC, eMLC, or SLC compositions.

In an embodiment of the disclosure, a non-volatile storage system daughter card is provided. The daughter card includes a circuitboard. The daughter card also includes non-volatile solid-state memory modules disposed on the circuitboard. The daughter card also includes at least one connector disposed on the circuitboard for removably connecting to a non-volatile storage system, the at least one connector in electrical communication with the non-volatile solid-state memory modules, the at least one connector including an addressing channel. When the daughter card is removably connected to a non-volatile storage system, the solid-state memory modules are controllable by the non-volatile storage system and the non-volatile storage system maintains a form factor after the daughter card is connected. In an embodiment, each of the at least one connectors includes at most one addressing channel. In an embodiment, the non-volatile storage system daughter card is capable of being removably connected to a plurality of non-volatile storage systems which differ in form factor while maintaining the form factor of each non-volatile storage system. In an embodiment, the plurality of non-volatile storage systems which differ in form factor include a 3.5 inch and 2.5 inch form factor non-volatile storage system. In an embodiment, the plurality of non-volatile storage systems which differ in form factor include a 2.5 inch and 1.8 inch form factor non-volatile storage system. In an embodiment, the daughter card further comprises at least one aperture for accommodating components of the non-volatile storage system. In an embodiment, the non-volatile solid-state memory modules and the at least one connector are disposed on the same side of the circuitboard.

### BRIEF DESCRIPTION OF THE DRAWINGS

FIGS. 1A and 1B illustrate the layout of a printed circuitboard for a fixed-capacity solid-state drive.

FIGS. 2A and 2B illustrate the layout of a main printed circuitboard for an expandable capacity solid-state drive.

FIGS. 3A and 3B illustrate the layout of a daughter card for an expandable capacity solid-state drive.

FIGS. 4, 5, and 6 illustrate logical structural diagrams of an expandable capacity solid-state drive.

FIG. 7 illustrates the physical architecture of an expandable capacity solid-state drive.

FIGS. 8A and 8B illustrate a channel layout for the bus of an expandable capacity solid-state drive according to an embodiment.

FIGS. 9A, 9B, and 9C illustrate addressing channel layouts for an expandable solid-state drive according to an embodiment.

### DETAILED DESCRIPTION

Details regarding several illustrative preferred embodiments for implementing the system and method described herein are described below with reference to the figures. At times, features of certain embodiments are described below in accordance with that which will be understood or appreciated by a person of ordinary skill in the art to which the device and method described herein pertain. For conciseness and readability, such a “person of ordinary skill in the art” is often referred to as a “skilled artisan.”

It will be apparent to a skilled artisan, in light of this disclosure, that certain components described herein can advantageously be implemented using computer software, hardware, firmware, or any combination of software, hardware, and firmware. In one embodiment, the device implements a controller as a single chip on a circuitboard. However, a skilled artisan will appreciate, in light of this disclosure, that any control logic that can be implemented using hardware can also be implemented using a different combination of hardware, software, or firmware. For example, such control can be implemented completely in firmware or with software on a general purpose computer.

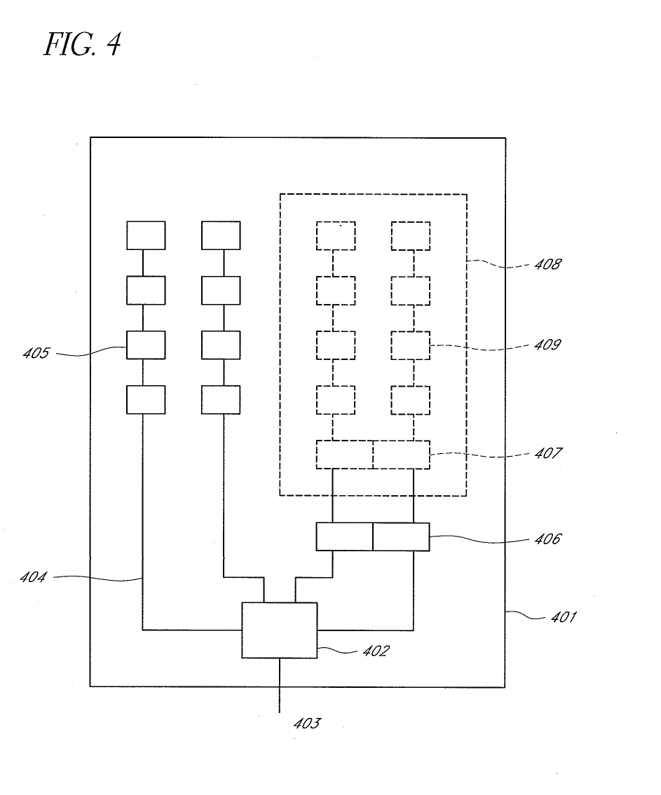

It will also be apparent to a skilled artisan, in light of this disclosure, that the modules described herein can be combined or divided. For example, a skilled artisan will appreciate, in light of this disclosure, that components on a circuitboard can be combined into one single component. Conversely, any one component can be divided into multiple components. For example, the controller 402 in FIG. 4 can be divided into multiple components such that each individual component performs part of the functions of the controller 402 and all of the components collectively perform all such functions.

The foregoing and other variations understood by a skilled artisan can be made to the embodiments described herein without departing from the invention. With the understanding therefore, that the described embodiments are illustrative and that the invention is not limited to the described embodiments, certain embodiments are described below with reference to the drawings.

“Flash chip” is a broad term and is to be given its ordinary and customary meaning to a person of ordinary skill in the art (i.e. it is not to be limited to a special or customized meaning) and includes, without limitation, non-volatile memory suitable for placement on a printed circuitboard. Typical flash chips include non-volatile NAND memory, which can comprise single-level cells (SLC), multi-level cells (MLC), or enterprise multi-level cells (eMLC). Flash chips can also include Memristor and Resistive-RAM.

“Solid state drive” (SSD) is a broad term and is to be given its ordinary and customary meaning to a person of ordinary skill in the art (i.e. it is not to be limited to a special or customized meaning) and includes, without limitation, a device providing non-volatile storage to a host device using at least one flash chip. A solid state drive may be of any form factor, including without limitation 3.5″, 2.5″, 1.8″, 1.0″, micro SD, or any other size known to a skilled artisan.

“Non-volatile” is a broad term and is to be given its ordinary and customary meaning to a person of ordinary skill in the art (i.e. it is not to be limited to a special or customized meaning) and includes, without limitation, a memory which maintains data stored in it without receiving any power.

“Daughter card” is a broad term and is to be given its ordinary and customary meaning to a person of ordinary skill in the art (i.e. it is not to be limited to a special or customized meaning) and includes, without limitation, any card or platform suitable for disposing one or more flash chips which is connected to another component while in operation, without regard to its size compared to other components of the system.

“Storage device” is a broad term and is to be given its ordinary and customary meaning to a person of ordinary skill in the art (i.e. it is not to be limited to a special or customized meaning) and includes, without limitation, any device providing non-volatile storage capacity to a host.

“User” is a broad term and is to be given its ordinary and customary meaning to a person of ordinary skill in the art (i.e. it is not to be limited to a special or customized meaning) and includes, without limitation, any end-user, technician, consumer, purchaser, or any other entity who interacts with a device after its manufacture.

An interface to an external device may be SATA, eSATA, IDE, miniSATA, SAS, MiniSAS HD, USB, Light Peak, MIDI (Mobile High-Definition Interface), Fiber Channel, Ethernet or other interfaces to a non-volatile storage device known to a skilled artisan.

### Fixed Capacity

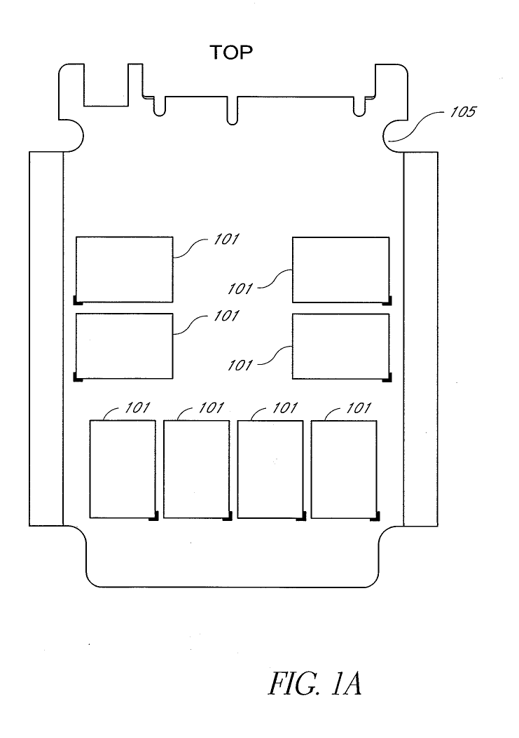

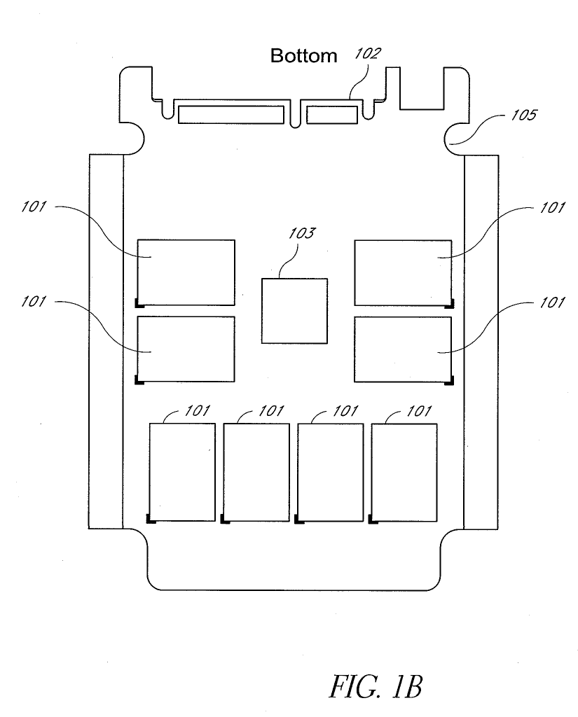

The disclosure of this application will now be made with reference to the Figures. Referring to FIGS. 1A and 1B, a solid-state drive (SSD) is shown. In this solid-state drive, a single printed circuitboard 105 is used within the drive casing. FIG. 1A shows the upper side of the printed circuitboard 105, and FIG. 1B shows the bottom side of the printed circuitboard 105 in this embodiment. As shown in this embodiment, the physical space on the printed circuitboard 105 is primarily occupied by flash chips 101 which are disposed on the upper and lower side of the single printed circuitboard 105. Not shown in FIGS. 1A and 1B are a variety of components also located on the circuitboard, such as capacitors, resisters, and other components for operation of the SSD.

In the embodiment of FIGS. 1A and 1B the lower side of the printed circuitboard also includes an interface to the host 102 and a controller 103. As described above, an interface to the host provides communication with a host, and can comprise any of a variety of well known specifications. The controller 103 receives communications from the host and performs memory operations on the flash chips 101. In the embodiment of FIGS. 1A and 1B, the SSD is limited to a fixed capacity as provided by flash chips 101.

### Expandable Capacity

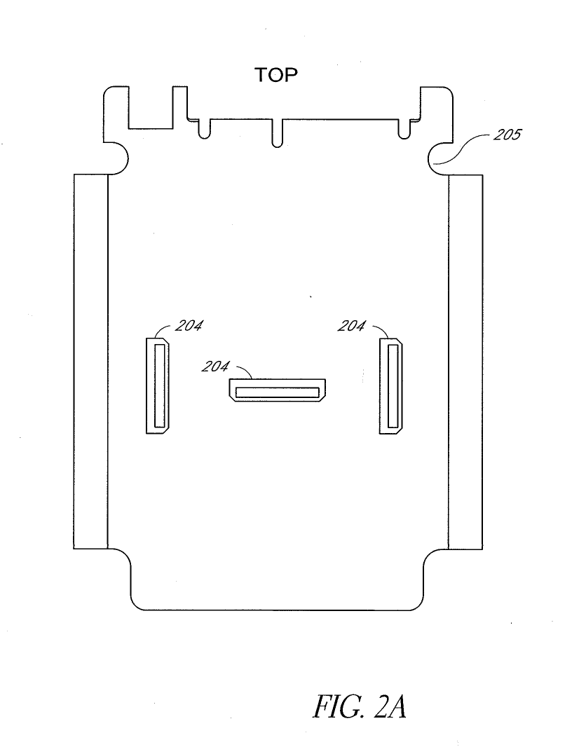

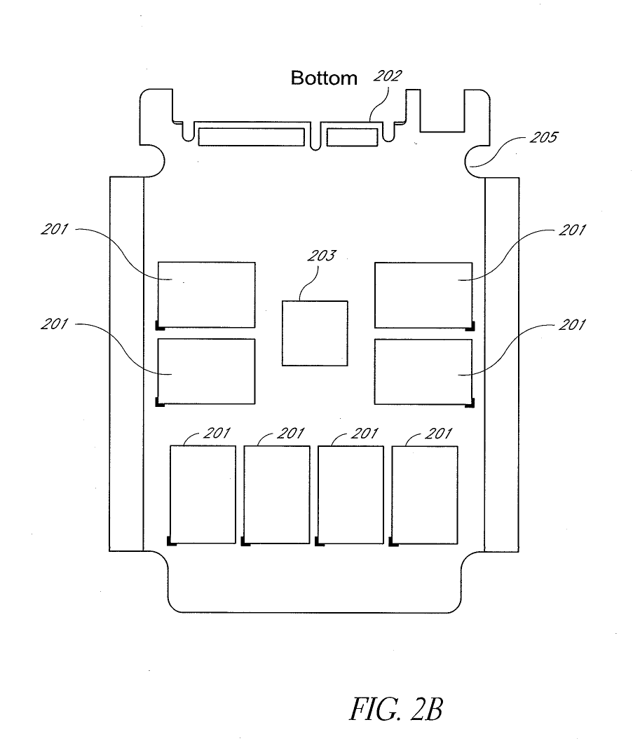

One embodiment of an expandable solid-state drive is presented in FIGS. 2A and 2B. FIG. 2B illustrates that the bottom side of a main printed circuitboard (PCB) 205 which includes flash chips 201. In this embodiment as shown by FIG. 2A, no flash chips are included on the top side of the main PCB 205. Connectors 204 are placed on the top side of the main PCB 205. In some embodiments, flash chips may also be included on the top side of the main PCB 205. The connectors provide the capacity for the main PCB 205 to removably receive a daughter card. The daughter card may include flash chips to provide additional storage capacity to the device.

The connectors 204 include pins that can provide an electronic connection between the daughter card and the controller and other components of the main PCB 205 when the daughter card is received. The connectors can be one half of any mating pair of connectors providing electrical communication between two printed circuitboards, such as 3M P05N Series plug/socket connectors. In this embodiment, three connectors are shown, but in alternate embodiments one or two connectors may be used between the main PCB 205 and the daughter card. In a two-connector embodiment, the connectors are parallel to one another and spaced about 39-40 mm apart. The number of connectors used may depend on the number of electrical connections to be carried by pins on the connectors. The bottom of the main printed circuitboard 205 as shown in FIG. 2B can include flash chips 201, interface to a host 202, and a controller 203. In this embodiment, the main PCB 205 includes flash memory. In other embodiments the main PCB does not include flash memory, in which case the SSD may present only the data storage capacity of any installed daughter card(s) to the host.

The controller 203 is configured to communicate with flash chips 201 as with FIGS. 1A and 1B. The controller 203 is also in communication with connectors 204. The controller 203 can be configured to communicate with flash chips on a daughter card when the daughter card is removably received by the connectors 204. When a daughter card is inserted, the controller can communicate with the flash chips on the daughter card.

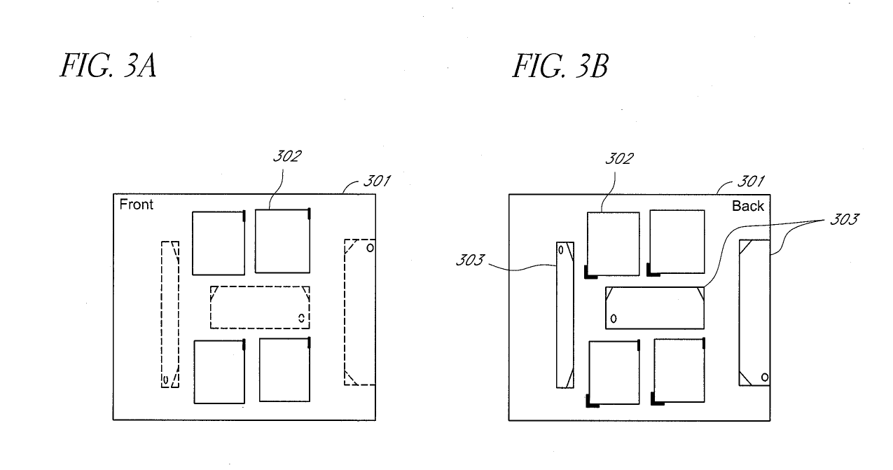

Referring now to FIGS. 3A and 3B, an embodiment for a daughter card 301 is shown which can be removably received by the main PCB 205 as depicted in FIGS. 2A and 2B. FIG. 3A shows the front and FIG. 3B shows the back of a daughter card. In this embodiment, daughter card 301 includes flash chips 302 disposed on the top and bottom of daughter card 301 as shown in FIGS. 3A and 3B. Daughter card 301 also includes connectors 303 configured to be removably received by a main PCB, such as 205 in FIGS. 2A and 2B. The flash chips 302 are in electrical connection with connectors 303 such that removably inserting the daughter card into the main PCB electrically connects flash chips 302 to the main printed circuitboard.

The embodiment of a daughter card of FIGS. 3A and 3B comprises four flash chips 302 on the top and four flash chips 302 on the bottom of the card. In other embodiments, a daughter card may have no chips on one side, or an arrangement of chips different from those illustrated. For example, disposing the flash chips on the same side as the connectors may advantageously reduce the vertical profile of the daughter card when received by the main PCB in the drive housing when compared to an embodiment with flash chips on both sides. Alternatively, disposing flash chips on both sides may maximize the number of flash ships which can be placed on a given daughter card surface area. As such, embodiments with flash chips on both sides may be advantageous where two or more daughter cards can be connected to a main PCB. While this Figure shows a total of eight flash chips on the daughter card, other embodiments may include any number of flash chips.

The flash chips 302 may be mounted to the daughter card in any typical package, such as TSOP, LGA, or BGA. One embodiment may use 48-pin TSOP flash chips to reduce the number of pins required to be transferred from the daughter card to the main printed circuitboard and thereby reduce the number of connectors 303 on the bottom side of the daughter card 301 as well as the number of connectors 204 on the top side of the main PCB 205.

When the daughter card is inserted into the main PCB, the original form factor of the device can be maintained by the combination. For example, a standard 2.5″ form-factor SSD may include 8 flash chips with a main PCB which includes a connector. After insertion of a daughter card, the combination of the main PCB and daughter card continues to meet the physical specifications for a standard 2.5″ drive. As such, the capacity of the drive can be expanded or new daughter cards inserted while maintaining adherence to the physical standards for a particular drive size. In certain embodiments, the daughter card is dimensioned to allow insertion into a 3.5″, 2.5″, or 1.8″ form factor device without changing the dimensions of the overall device. This can allow the same daughter card to be used across different SSD form factors. For this interoperability, the daughter card can use a common dimension and connector configuration across SSD sizes.

Referring now to FIG. 4, a schematic diagram illustrating an embodiment of the solid state drive is shown. The main PCB 401 contains a controller 402, an interface to the host 403, an interface bus 404, flash chips 405, and connectors 406. The controller 402 interfaces with flash chips 405 and, if daughter card 408 is connected, with flash chips 409 through connectors 406 and 407. The main PCB 401 also contains a clock and other components (not shown) to operate the flash chips 409. Connector 406 can removably receive connector 407 located on daughter card 408.

When daughter card 408 is connected to the main PCB 401, the controller 402 is configured to use flash chips 409 as well as flash chips 405. Controller 402 may present the combined capacity of flash chips 405 and 409 as the total capacity of the drive to host interface 403. Controller 402 may make use of virtualization within the solid state drive, allowing flash chips 405 and flash chips 409 to be of differing capacities and the aggregated capacity to be presented to the interface to host 403. Controller 402 may also allow cloning within the solid state drive, which would allow cloning of data between flash chips 405 and flash chips 409. Once the data has been cloned, the user may exchange the daughter card with an equivalent or higher capacity daughter card.

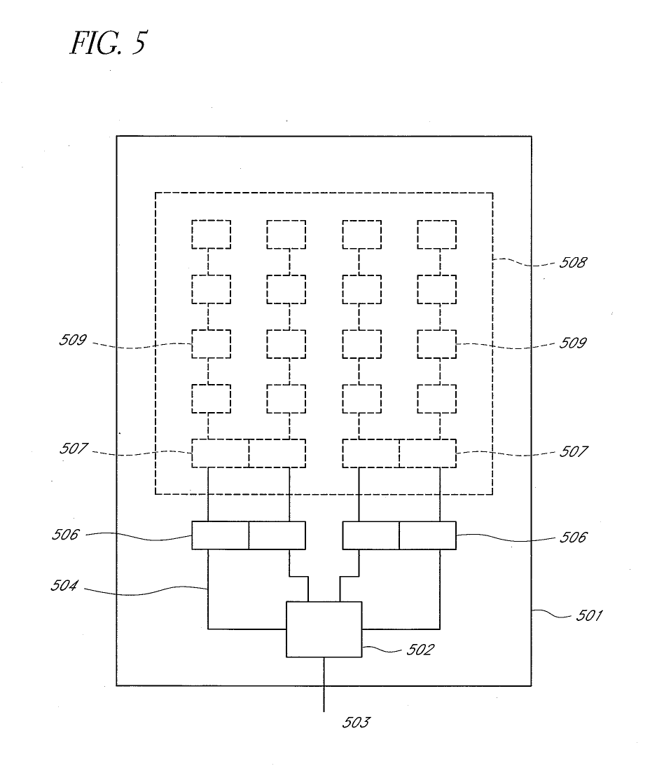

Another embodiment is presented in FIG. 5 wherein the expandable solid state drive does not have any flash chips on the main PCB 501. Main PCB 501 comprises a controller 502, an interface bus 504, an interface to host 503, and at least one connector 506. Daughter card 508 comprises flash chips 509 and connectors 507. Connectors 507 may be removably received by the connectors 506 on the main PCB 501. When connectors 507 are received by connectors 506, flash chips 509 are in electronic contact with controller 502. Controller 502 is configured to interact with flash chips 509 as described above. When daughter card 508 is connected to the main PCB, the controller can interact with flash chips 509 and present the memory capacity of flash chips 509 for use through the interface to a host 503.

After the data on flash chips 509 is backed up to the host system, the user may exchange a daughter card with an equivalent or higher capacity daughter card and then restore the data from the system to flash chips on the new non-volatile memory module. The embodiment of FIG. 5 allows a user to re-use the controller and main PCB, replacing only the daughter card 508. The capacity of the device can then be increased while limiting the cost to the replacement of the daughter card and re-using the controller and interface. A user may also choose to replace the daughter card in order to use flash chips with different endurance and performance profiles, for example exchanging among daughter cards using flash chips constructed with MLC, eMLC, and SLC chips.

Alternatively, the user may re-use daughter card 508 by replacing the main PCB 501 and inserting the daughter card 508 into another main PCB. This enables a user to, for example, replace a main printed circuitboard which has become defective, use a main PCB which has a controller with improved performance, or use a main PCB with an alternate interface to a host device.

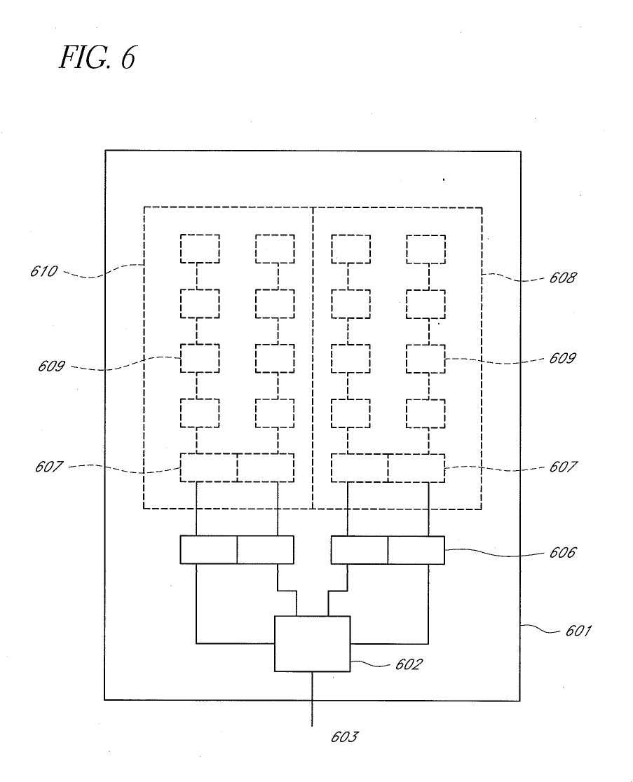

An embodiment is presented in FIG. 6 wherein two daughter cards may be used to expand the capacity of the SSD. Daughter cards 608 and 610 each contain flash chips 609 and connectors 607. Each daughter card may be received by connectors 606. Each daughter card 608 or 610 may be connected to main PCB 601 either alone or together. When a daughter card is connected to the main PCB, controller 602 can interface with the flash chips of that daughter card and present the capacity of the flash chips to a host through the interface 603. If both daughter cards 608 and 610 are inserted, the controller 602 may aggregate the capacities of the flash chips 609 on each daughter card for logical presentation to a host. The controller 602 may use virtualization to aggregate flash chips of differing capacities and may allow cloning from one daughter card to the other as previously described.

These features as described with respect to FIGS. 4, 5 and 6 allow the SSD device to scale up its capacity and extend its life cycle. Users may take advantage of the expandability, virtualization, cloning, and backup/restore to purchase or replace new modules timed with the user's needs or a decrease in market price. In these embodiments, the storage component is separated from the control and interface components and allows switching of daughter cards used with a particular main PCB.

### Physical Layout

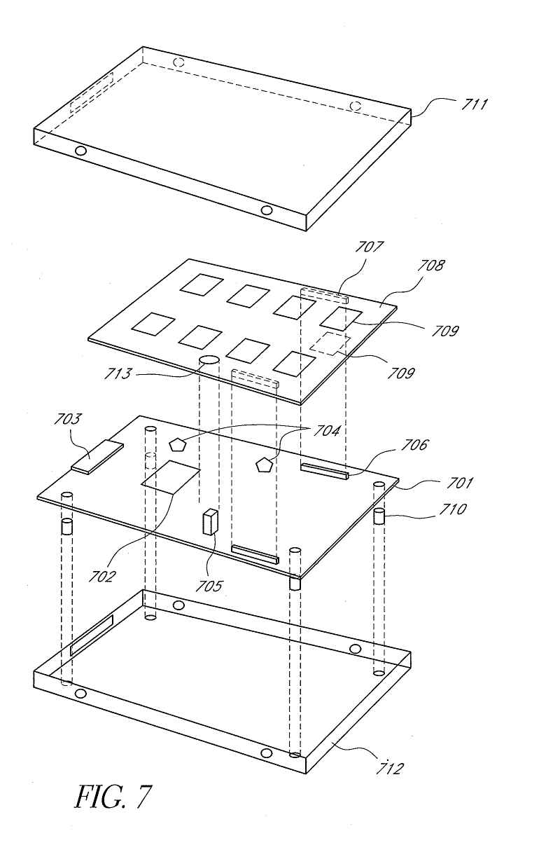

The physical layout for an embodiment of an expandable solid state drive is depicted in FIG. 7. The solid state drive is comprised of top cover 711, daughter card 708, main PCB 701, and bottom cover 712. Main PCB 701 is held above bottom cover 712 by posts 710. Daughter card 708 rests above main PCB 701 and is held in place when connectors 707 on daughter card 708 are received by connectors 706 on main PCB 701. Top cover 711 may be removed and replaced to provide access to insert or remove daughter card 708. Top cover 711 may consist of one or two pieces of metal or other protective material.

Top cover 711 may be easily removable to aid a user in accessing the main PCB 701 for insertion of daughter card 708. Top cover 711 may be wholly or partially removed or hinged to allow insertion of daughter card 708. In an alternate embodiment, top cover 711 is located immediately above the main PCB 701, and includes an aperture located above connector 706 for insertion of a daughter card's connector through the aperture. The form factor of the device may be maintained before and after insertion of the daughter card through each of these top cover variations.

As shown, Flash chips 709 may be located on the top and/or bottom of daughter card 708. In addition the Main PCB may include flash chips as well. If the Main PCB does include flash chips, they can be positioned on the side of the Main PCB closest to the bottom cover 710 (not shown). Alternatively, in some embodiments flash chips may be positioned on both sides of the main PCB or on the side closest to the top cover.

Components 704 and 705 are disposed along the main PCB. These components are standard components for a solid state drive, and may include any components attached to the main PCB to operate the controller 702 or flash chips 709. Such components may include capacitors, resistors, ICs, regulators, volatile DRAM cache, and other elements.

When daughter card 708 is connected to main PCB 701, the form factor of the solid state drive may be maintained. To accommodate the daughter card 708 while maintaining a form factor, it is preferable to minimize height requirements of each piece in the device. Accordingly, the connectors 706 and 707 may be mating 3M P05N Series plug/socket connectors, with a mated height of 3 mm. Alternatively, the connectors may be low-profile SODIMM connectors with a high pin count and fine pitch.

A form factor is the external physical dimensions of the SSD. To maintain the form factor means that before and after the installation of the daughter card 708, the SSD has the same physical dimensions. While some form factors are standardized, such as a 2.5″ 9.5 mm drive, any form factor is possible while maintaining the concepts of this application. Maintaining form factors can be particularly important in many situations because other components typically provide a fit for a specific form factor of a device. As such, the ability to change the capacity of an SSD while being able to install the SSD in the same locations is particularly valuable.

Certain tall components 705 to be used on main PCB 701 may be of a height physically incompatible with the insertion of the daughter card. Tall components 705 may be accommodated in a variety of ways. First, aperture 713 may be included on daughter card 708 to accommodate tall components 705. Second, tall components 705 may be disposed on the bottom side of main PCB 701, provided tall components 705 do not contact bottom cover 712. Third, tall components may be disposed on the main PCB near Interface 703 or at another location where the inserted daughter card does not extend to cover the main PCB. Fourth, daughter card 708 may have no flash chips 709 disposed above tall components 705 such that tall components 705 are not contacted when daughter card 708 is inserted. The allowable height for components may differ for each of these solutions. Each tall component may therefore be eligible for different accommodations.

For a standard 2.5″ form factor for a solid state drive having a maximum height of 9.50 mm, the following heights allow for the insertion of a daughter card while maintaining the form factor:

| Component | Height |
|---|---|
| Top cover | .50 mm |
| Daughter card | .76 mm |
| Flash chips on bottom side of | 1.10 mm |
| daughter card | |
| Connectors (mated height) | 3.00 mm |
| Main PCB | 1.04 mm |
| Post | 3.48 mm |
| Bottom Cover | .5 mm |

In this embodiment, the daughter card may not have any flash chips on its top side to provide additional clearance. The daughter card's flash chips may be located on the under side of the daughter card. As such, the daughter card flash chips occupy the same vertical space as the connectors and provide no additional height requirements. Likewise, the flash chips on the lower side of the main PCB provide no additional height requirements because the main PCB is supported by a post.

For a standard 2.5″ form factor for a solid state drive having a maximum height of 12.50 mm, the SSD with these heights can allow for maintaining the form factor after installation of the daughter card:

| Component | Height |
|---|---|
| Top cover | .50 mm |
| Flash chips on top side of | 1.10 mm |
| daughter card | |
| Daughter card | .76 mm |
| Flash chips on bottom side of | 1.10 mm |
| daughter card | |
| Connectors (mated height) | 3.00 mm |
| Main PCB | 1.04 mm |
| Post | 3.48 mm |
| Bottom Cover | .5 mm |

For a standard 2.5″ form factor solid state drive, having a maximum height of 12.50 mm, using the above measurements, tall components 705 constitute any components for placement on the main PCB which are taller than 2.12 mm. Components taller than 2.12 mm may conflict with the daughter card if flash chips are disposed on the bottom of the daughter card. The following heights correspond to the maximum height allowable of tall components 705 for the varying accommodation solutions enumerated above: tall components disposed to correspond with aperture in daughter card: 6.98 mm, bottom side of main PCB: 3.48 mm, top side of main PCB where daughter card does not extend over component: 6.98 mm, top side of main PCB where daughter card has no flash chips disposed: 3.00 mm.

In alternate embodiments, two or more daughter cards may be inserted simultaneously while maintaining the form factor of the drive. In these embodiments, main PCB 701 may contain additional connectors 706 to facilitate addition of a second daughter card.

A method is also presented for expanding a solid state drive. A solid state drive is expanded by removing the cover in whole or in part, and adding a daughter card to a main PCB by removable connectors, the daughter card comprising at least one flash chip, said daughter card, when received by said main PCB, providing increased usable memory to a controller. The addition of a daughter card in accordance with this method may optionally maintain the form factor for the solid state device. A solid state drive may also be expanded by adding a daughter card to a main PCB by removable connectors, the connectors mating through an aperture in cover of the main PCB or by insertion through a hinge in the cover, wherein after addition of the daughter card, the solid state drive maintains a form factor.

One advantage is that it allows a user to easily expand the size of a solid-state drive by inserting a new daughter card. An SSD with a daughter card already installed can also switch the installed daughter card by installing a new daughter card, for example by providing a daughter card with increased performance or endurance compared to the installed daughter card. In addition, a user can insert a daughter card into an alternate SSD with a compatible connector and easily transfer the data and capacity for the daughter card. This can provide the user alternatives in case there is a defect in the original SSD components and allow the user to continue to use the daughter card. The alternate SSD can also provide improved controller functionality or an alternate interface to the daughter card. In addition, the user can connect the daughter card to different sizes of SSD, for example moving a daughter card from a 3.5″ drive to a 2.5″ drive or a 2.5″ drive to a 1.8″ drive. These techniques allow a user the ability to expand a drive quickly and easily through use of connectors which are easily useable by an individual and can be handled and inserted without any solder or other complicated mating procedure.

### Controller

When a daughter card is inserted into a SSD, the controller can recognize the capacity of the daughter card and provide the capacity to the host. This can be accomplished in a variety of ways. A controller may be hard configured with the capacity of the connected flash chips. In this case, the controller may need to run manufacturer configuration through the interface for the new capacity to set configured on the controller. In another embodiment, the controller may run an initialization routine when it powers up. This initialization routine may check for all connected flash chips. If the controller recognizes additional flash chips or flash chips with improved performance, the controller can change its performance to accommodate the capacity of the installed chips or accommodate the performance characteristics of the installed flash chips. A further embodiment of a controller can recognize a daughter card as it is inserted. In this embodiment, the controller may determine with the host device controller whether the host is compatible with a change in the device size, or whether the host must first be re-started to accept the new device capacity.

### Bus Channel Routing

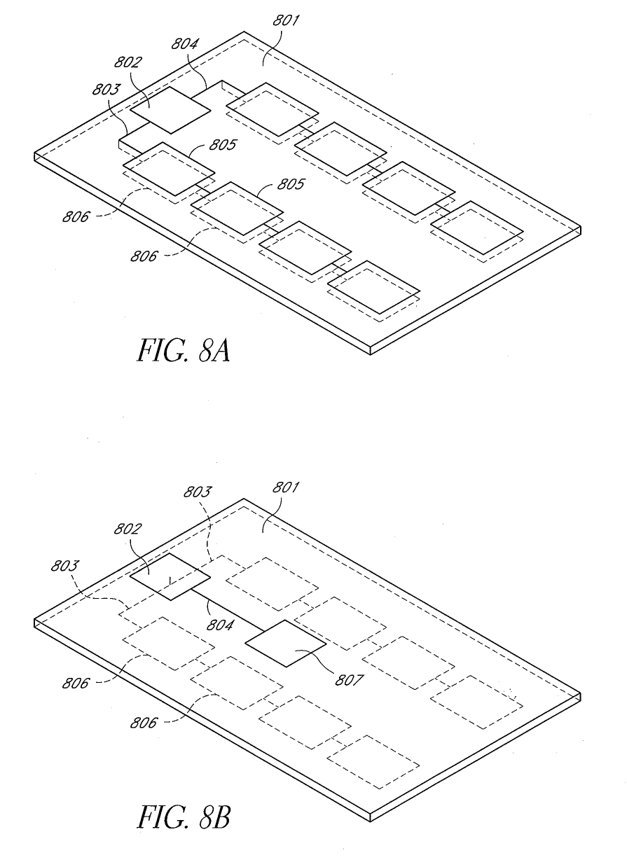

Referring to FIG. 8A, the addressing bus of a solid state drive is shown. In this embodiment, a printed circuitboard 801 includes a controller 802 and flash chips 805 and 806. Flash chips 805 are disposed on the top of the printed circuitboard 801 and flash chips 806 are disposed on the bottom of the printed circuitboard 801. Controller 802 may communicate with flash chips using two groups of addressing channels 803 and 804. The addressing bus provides a common addressing and signaling bus for the connected flash chips. As shown in FIG. 8A, addressing channel group 803 is in communication with flash chips 805 and 806 disposed on the top and bottom along one side of the main printed circuitboard 801. Addressing channel group 804 is in communication with the flash chips 805 and 806 on the other side of the main printed circuitboard 801. In this embodiment, a channel group is shared between flash chips on the top and bottom of the printed circuitboard 801.

In FIG. 8B, an embodiment is shown including a connector 807. The connector 807 can represent a single or plurality of connectors for a daughter card. In this embodiment, there are no flash chips disposed on the top of the printed circuitboard 801. The flash chips 806 are disposed on the bottom of the printed circuitboard 801. In this embodiment, a single addressing channel group 803 connects all flash chips 806 disposed on the bottom of the printed circuitboard 801. Addressing channel group 804 communicates with connector 807. In embodiment, when the connector 807 engages a connector with a daughter card, the connector 807 only needs to carry a single addressing channel group 804 to the daughter card. By manipulating the addressing channel locations, the number of pins required for connector 807 can be reduced. Reducing the number of pins required for connector 807 can also reduce the number of connectors required to carry signals to the daughter card.

For embodiments in which two daughter cards can be used, such as shown by FIG. 6, each daughter card can communicate with a single addressing channel group, which can reduce the number of pins required for the connectors for each daughter card. For controllers which use more than two addressing channel groups, pins required on the connectors may be reduced by increasing the number of it chips on a daughter card assigned to individual channels.

### Two-Channel Flash Chip Addressing

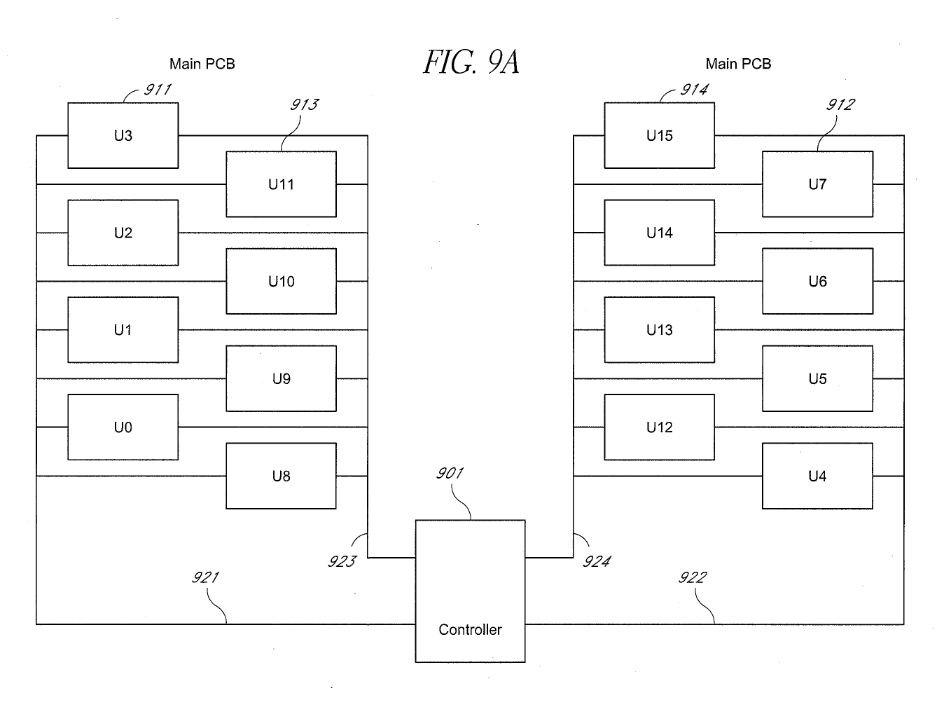

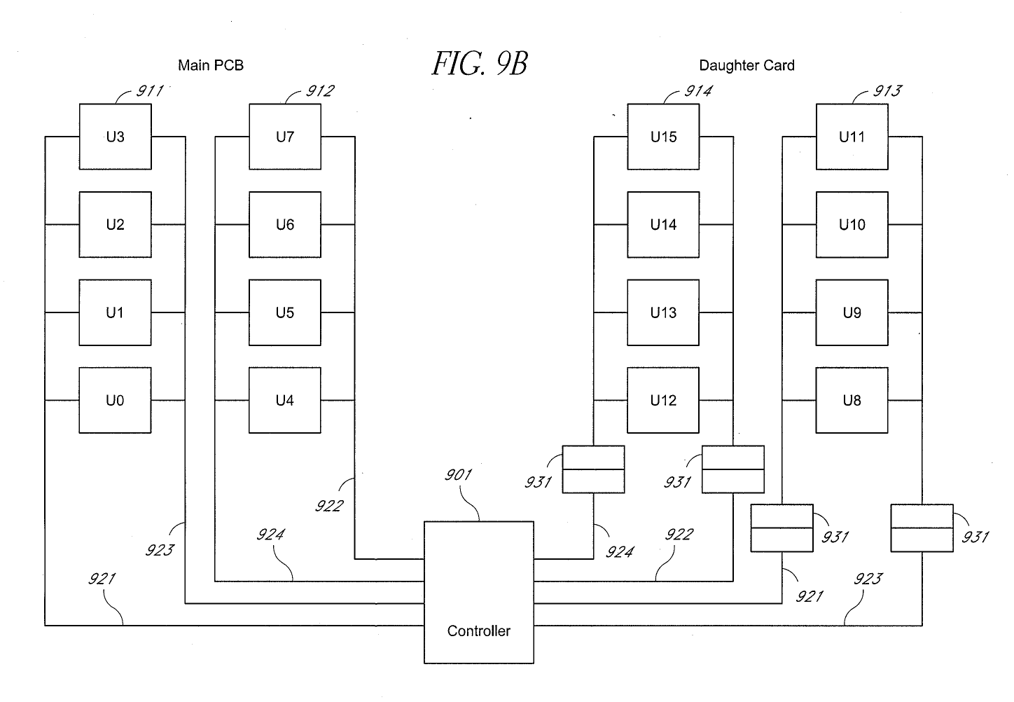

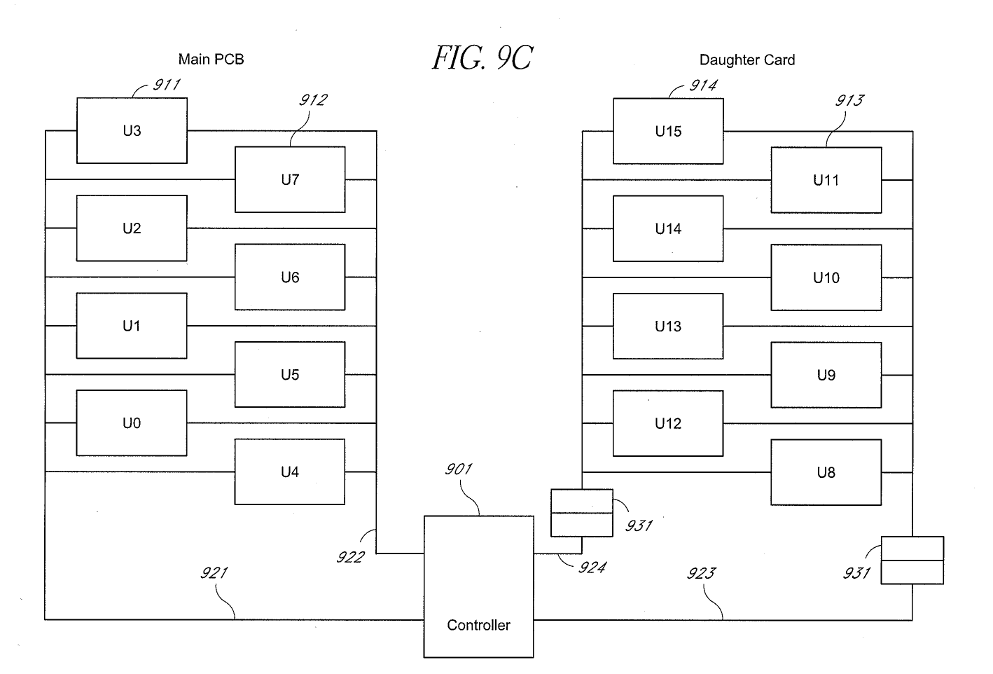

FIGS. 9A, 9B, and 9C illustrate channel addressing which can be used for embodiments with flash chips which allow two-channel inputs. Similar techniques can be used for flash chips with more than two channel inputs. FIG. 9A depicts a SSD with flash chips U0 through U15 disposed on a main PCB.

In this embodiment, flash chips can be addressed by a controller 901 using addressing channel groups 921, 922, 923, and 924. As shown, flash chips 911 are simultaneously addressed by addressing channel group 921 and 923. In this embodiment, each addressing channel group comprises a group of four channels, each channel capable of addressing two flash chips. Likewise, each flash chip is capable of receiving two addressing channels. For example, one channel in addressing channel group 921 may connect to flash chip U0 and U8. Flash chip U0 may connect to one channel in addressing channel group 921 and one channel group in addressing channel group 923.

Controller 901 provides data and control to the flash chips using the addressing channel groups. In some embodiments, controller 901 may contain two processing components, each responsible for controlling two addressing channel groups. For example, one processing component can control addressing channel groups 921 and 923, and another processing components can control addressing channel groups 922 and 924. In some embodiments, the processing components may be divided among more than one controller.

The flash chips shown in FIG. 9A may be disposed on the top and bottom side of a main PCB for a SSD. In some embodiments, flash chips 911 and 912 are disposed on one side of the PCB and flash chips 913 and 914 are disposed on the other side.

FIG. 9B depicts an addressing channel group organization with a daughter card. In this embodiment, flash chips 913 and 914 are now disposed on a daughter card instead of one side of the PCB as in FIG. 9A. As shown, the flash chips are connected to the same addressing groups as in FIG. 9A. As such, flash chips 911 and 912 are disposed on the main PCB and are connected to addressing channel groups 921 and 923 for flash chips 911, and addressing channel groups 922 and 924 for flash chips 912.

The flash chips 913 and 914 are disposed on a daughter card and connect to the main PCB by connectors 931. Though four separate connectors 931 are shown, these connectors may be combined or further divided. Flash chips 913 are connected to addressing channel group 921 and 923, and Flash chips 914 are connected to addressing channel group 922 and 924. In this embodiment, addressing channel groups 921, 922, 923, and 924 are passed through a connector to the daughter card.

The embodiment shown by FIG. 9C provides an alternative to FIG. 9B which reduces the number of connectors 931. Reducing the number of connectors can provide increased space in the physical layout for other components. As shown in FIG. 9C, the addressing channel groups are organized to provide addressing channel groups 923 and 924 through connectors 931 which reduce the number of addressing channel groups which pass through the connectors 931 relative to FIG. 9B. In this embodiment, flash chips 913 and 914 are each connected to addressing channel groups 923 and 924. The flash chips on the main PCB, 911 and 912, connect to addressing channel groups 921 and 922.

In embodiments with two processing components for the controller 901, each processing component can be connected to one addressing channel group for the main PCB and one addressing channel group for the daughter card. In this circumstance, each processing component has a group of flash chips to interact with prior to insertion of the daughter card. This can improve performance by spreading the processing and control for the flash chips among the processing components. In alternate embodiments, a processing component may connect solely to addressing groups associated with a daughter card and have no addressing channel groups associated with the main PCB, in which case that processing component can be entirely idle until a daughter card is detected. In some embodiments, flash chip groups 911 and 912 may also be located on a daughter card, where no flash chips are present on the main PCB. In these embodiments, addressing channel groups for each daughter card may be split among processing components for the controller or associated with a single processing component.

### CONCLUSION

It is understood in the foregoing embodiments that while a plurality of flash chips and connectors may be depicted, a skilled artisan will understand that these embodiments include use of one or more in accordance with these embodiments.

The embodiments described above can be used in a variety of situations advantageous for the user. For example, a user can double the capacity of the SSD by adding a daughter card with additional flash chips to complement the flash chips on the device PCB. In embodiments without any memory on the main PCB, a user can upgrade the type or quality of memory by changing the daughter card to another daughter card with increased capacity or quality parameters (e.g. performance and endurance). A user may also choose to move the daughter card to another device with a different controller. As memory management techniques improve on controller firmware, it may be advantageous to move a daughter card to take advantage of these improved techniques. Moving the daughter card may also be advantageous to use different interfaces. For example, a daughter card can be moved from a main PCB which has a SATA interface to a main PCB which has a USB interface. In addition, the daughter card could be moved from a main PCB using an interface with USB 2.0 to a main PCB with an interface using USB 3.0, or from a current interface to any new interface that is developed. As such, any interface to a host is contemplated by this disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements and/or states are in any way required for one or more embodiments or that one or more embodiments necessarily include logic for deciding, with or without author input or prompting, whether these features, elements, and/or states are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

Although this invention has been disclosed in the context of a certain preferred embodiment and examples, it will be understood by those skilled in the art that the present invention extends beyond the specifically disclosed embodiment to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combination or sub-combinations of the specific features and aspects of the embodiments or variations may be made and still fall within the scope of the invention. It should be understood that various features and aspects of the disclosed embodiment can be combined with or substituted for one another in order to form varying modes of the disclosed invention. Thus, it is intended that the scope of the present invention herein-disclosed should not be limited by the particular disclosed embodiments described above, but should be determined only by a fair reading of the claims that follow.

What is claimed is:

1. A non-volatile storage device, comprising:
a printed circuitboard;
a controller, capable of interfacing with non-volatile memory;
an interface, capable of providing logical access to the controller for an external host;
at least one connector suitable for removably receiving at least one daughter card, wherein each daughter card includes at least one mating connector and at least one non-volatile solid-state memory module; and
an interface bus, providing an electrical connection between said connectors and said controller;
wherein said controller is configured to utilize said at least one non-volatile memory module when the at least one daughter card is removably received, and
wherein a form factor of the device is maintained after receipt of the at least one daughter card.

2. The non-volatile storage device of claim 1, wherein the form factor of the device is one of a standard 3.5, 2.5, or 1.8 inch drive.

3. The non-volatile storage device of claim 1, wherein the printed circuitboard further includes a main non-volatile memory.

4. The non-volatile storage device of claim 3, wherein the controller is further configured to aggregate the capacities of the main non-volatile memory and the non-volatile memory module of the at least one received daughter card and present the aggregated capacities to the external host.

5. The non-volatile storage device of claim 1, wherein the interface bus includes a plurality of channels, each channel capable of addressing a limited set of non-volatile memory modules, wherein each of the at least one connector includes a channel for communication with a daughter card.

6. The non-volatile storage device of claim 1, wherein the controller is configured for communication with non-volatile memory modules of the daughter card which comprise any of MLC, eMLC, or SLC compositions.

7. A non-volatile storage system daughter card, comprising:
a circuitboard;
non-volatile solid-state memory modules disposed on the circuitboard; and
at least one connector disposed on the circuitboard for removably connecting to a non-volatile storage system, the at least one connector in electrical communication with the non-volatile solid-state memory modules, the at least one connector including an addressing channel;
wherein when the daughter card is removably connected to a non-volatile storage system, the solid-state memory modules are controllable by the non-volatile storage system and the non-volatile storage system maintains a form factor after the daughter card is connected.

8. The non-volatile storage system daughter card of claim 7, wherein each of the at least one connectors includes at most one addressing channel.

9. The non-volatile storage system daughter card of claim 7, wherein the non-volatile storage system daughter card is capable of being removably connected to a plurality of non-volatile storage systems which differ in form factor while maintaining the form factor of each non-volatile storage system.

10. The non-volatile storage system daughter card of claim 9, wherein the plurality of non-volatile storage systems which differ in form factor include a 3.5 inch and 2.5 inch form factor non-volatile storage system.

11. The non-volatile storage system daughter card of claim 9, wherein the plurality of non-volatile storage systems which differ in form factor include a 2.5 inch and 1.8 inch form factor non-volatile storage system.

12. The non-volatile storage system daughter card of claim 7 further comprising at least one aperture for accommodating components of the non-volatile storage system.

13. The non-volatile storage system daughter card of claim 7 wherein the non-volatile solid-state memory modules and the at least one connector are disposed on the same side of the circuitboard.
